(19) United States
(12) Patent Application Publication
(10) Pub. No.: US 2013/0255058 A1
(43) Pub. Date: Oct. 3, 2013

(54) Attachment System and Method of Using the Same

(71) Applicant: SOUCY INTERNATIONAL INC., Drummondville (CA)

(72) Inventors: Michel Pellerin, St-Charles-de-Drummond (CA); Maxime Brunet, Drummondville (CA); Guillaume Provencher, St-Germain-de-Grantham (CA)

(73) Assignee: Soucy International Inc., Drummondville (CA)

(21) Appl. No.: 13/852,037

(22) Filed: Mar. 28, 2013

Related U.S. Application Data
(60) Provisional application No. 61/616,449, filed on Mar. 28, 2012.

(51) Int. Cl. F16B 17/00

(52) U.S. Cl. CPC F16B 17/00
USPC 29/428; 403/376

(57) ABSTRACT

An attachment system for securing an accessory (e.g. a bumper) to a vehicle (e.g. an all-terrain vehicle) is disclosed. The attachment system generally comprises at least one locking mechanism mounted to, or integral with, the accessory, and at least one receiving member, mounted to, on integral with, the vehicle. The locking mechanism generally comprises an actuator configured to actuate or displace at least one locking arm between an inoperative (or unlocked) position and an operative (or locked) position. The receiving member generally comprises at least one opening configured to receive therein at least a portion of the locking mechanism. The attachment system generally allows the installation and removal of the accessory by actuating the actuator of the at least one locking mechanism.

### CROSS-REFERENCE TO RELATED APPLICATIONS

The present patent application claims the benefits of priority of U.S. Provisional Patent Application No. 61/616,449, entitled “Attachment System and Method of Using the Same”, and filed at the United States Patent and Trademark Office on Mar. 28, 2012, the content of which is incorporated herein by reference.

### FIELD OF THE INVENTION

The present invention generally relates to attachment systems and mechanisms for securing an accessory to a vehicle and more particularly relates to attachment systems and mechanisms for removably securing an accessory to a vehicle.

### BACKGROUND OF THE INVENTION

All-terrain vehicles (“ATV” or “ATVs”), utility-terrain vehicle (“UTV” or “UTVs”), side-by-side vehicles (“SSV” or “SSVs”), and other vehicles, are often equipped with accessories in order to modify the appearance and/or performances of the vehicle, since such vehicles are often used to perform different kinds of works and/or used in different environments.

Hence, it is generally desirable to be able to easily install and remove accessories to such vehicles.

In the case of bumpers, most attachment systems typically involve the use of bolts and nuts or self-threading bolts which must be installed to or behind supporting plates on the vehicle. However, conventional nuts and bolts and self-threading bolts attachment systems have their shortcomings. For instance, it is often difficult to access the nuts located behind the supporting plates. Also, the threads of the bolts, of the nuts and/or of the supporting plates can easily become damaged or stripped. Furthermore, some of the hardware can become lost when it is not initially mounted to or installed on the bumper.

There is thus a need for an attachment system for an accessory, typically but not necessarily a bumper, which allows the installation and removal of the accessory while mitigating at least some of the shortcomings of the prior art.

### SUMMARY OF THE INVENTION

In accordance with the principles of the present invention, there is provided an attachment system which allows an easy yet secured installation of an accessory to a vehicle. The attachment system also allows the removal of the accessory if needed.

The attachment system generally comprises at least one locking mechanism and at least one receiving member. The at least one locking mechanism is generally mounted to, or integral with, the accessory. Similarly, the at least one receiving member is generally mounted to, or integral, with the vehicle.

The locking mechanism generally comprises a housing having pivotally mounted thereto an actuator and at least one locking arm.

The actuator is configured to actuate or displace the at least one locking arm between an unlocked or inoperative position, and a locked or operative position. The actuator is typically configured to be actuated by a human operator using a tool or even by hand.

The at least one receiving member generally comprises at least one opening or cavity configured to receive therein at least a portion of the locking mechanism.

When the locking mechanism is received into the opening of the receiving member, the actuator is rotated such as to displace the at least one locking arm from its inoperative position to its operative position such that the at least one locking arm engages the side of the opening in a locked engagement.

In typical yet non-limitative embodiments, the housing comprises a protruding plug portion that is configured to be received in the opening (or cavity) of the receiving member. The plug portion generally defines a shoulder with the main portion of the housing such as to limit its insertion into the opening. In such embodiments, the plug portion typically has a cross-section which shape is substantially complementary to the shape of the opening in order for the plug portion to properly engage the opening. In that sense, the free extremity of the plug portion is typically tapered to facilitate the insertion of the plug portion into the opening.

The plug portion also typically comprises at least one side opening through which the extremity of the at least one locking arm can extend in its operative position to engage the side of the opening. Understandably, the plug portion will typically comprise as many side openings as there are locking arms.

In some embodiments, the plug portion may also comprise a groove located near or at its base (e.g. near the shoulder). The groove is generally configured to engage the side of the opening. In that sense, the groove is typically located opposite the side opening.

In typical yet non-limitative embodiments, the locking mechanism comprises at least one locking arm pivotally mounted to the housing. The at least one locking arm typically comprises an engaging portion configured to engage the side of the opening (or cavity). In that sense, the engaging portion is generally, though not necessarily, shaped as a hook, and is generally located at the extremity of the locking arm.

In some embodiments, the at least one locking arm may be provided with a biasing or recall mechanism (e.g. a coil spring) to bias the at least one locking arm into the inoperative position.

In typical yet non-limitative embodiments, the actuator is pivotally mounted to the housing. The actuator generally comprises a first extremity and a second extremity. The first extremity is typically configured to be engaged by hand or by a tool (e.g. a screwdriver, an Allen key, a wrench, etc.) in order for the operator to be able to rotate the actuator. For its part, the second extremity is typically configured to engage the at least one locking arm in order for the actuator to cause the displacement of the at least one locking arm between the inoperative and operative positions when pivoted.

In some embodiments, the actuator is a threaded actuator and is threadedly mounted to the housing.

In typical though non-limitative embodiments, the accessory is a bumper.

In typical though non-limitative embodiments, the vehicle is an all-terrain vehicle (“ATV”), a utility terrain vehicle (“UTV”), or a side-by-side vehicle (“SSV”).

Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1 is a front perspective view of a partially shown ATV having mounted thereto a bumper via an embodiment of an attachment system in accordance with the principles of the present invention.

FIG. 2 is a side perspective partially exploded view of the ATV and the bumper of FIG. 1.

FIG. 3 is an outer perspective view of the bumper and the attachment system of FIG. 1 as mounted to the ATV.

FIG. 4 is an inner perspective view of the bumper and the attachment system of FIG. 1 as mounted to the ATV.

FIGS. 5A to 5C are sequential perspective views of the attachment system of FIG. 1 during its installation.

FIGS. 6A to 6D are perspective and cross-sectional views of the embodiment the attachment system shown in FIG. 1.

FIGS. 7A to 7D are perspective and cross-sectional views of another embodiment of an attachment system in accordance with the principles of the present invention.

FIGS. 8A to 8D are perspective and cross-sectional views of another embodiment of an attachment system in accordance with the principles of the present invention.

FIGS. 9A to 9D are perspective and cross-sectional views of another embodiment of an attachment system in accordance with the principles of the present invention.

FIGS. 10A to 10D are perspective and cross-sectional views of another embodiment of an attachment system in accordance with the principles of the present invention.

FIGS. 11A to 11C are perspective and cross-sectional views of another embodiment of an attachment system in accordance with the principles of the present invention.

### DETAILED DESCRIPTION OF PREFERRED EMBODIMENTS

A novel attachment system and a method of using the same will be described hereinafter. Although the invention is described in terms of specific illustrative embodiments, it is to be understood that the embodiments described herein are by way of example only and that the scope of the invention is not intended to be limited thereby.

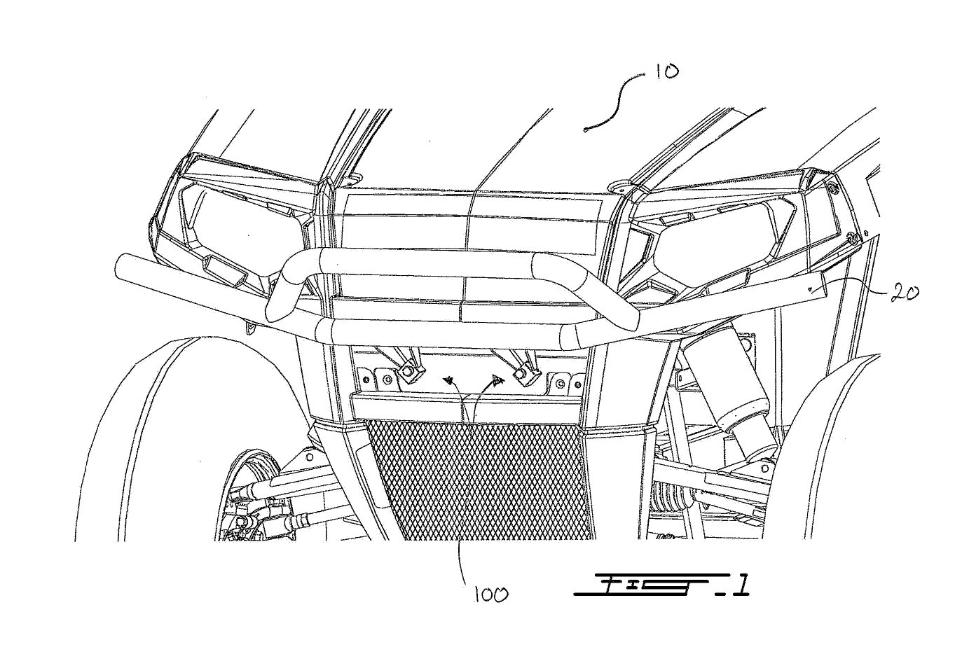

Referring first to FIG. 1, a vehicle 10 is shown having mounted thereto a bumper 20 using a first embodiment of an attachment system 100 in accordance with the principles of the present invention.

In FIG. 1, the vehicle 10 is an ATV but the vehicle 10 could be a UTV, a SSV, or any other vehicles.

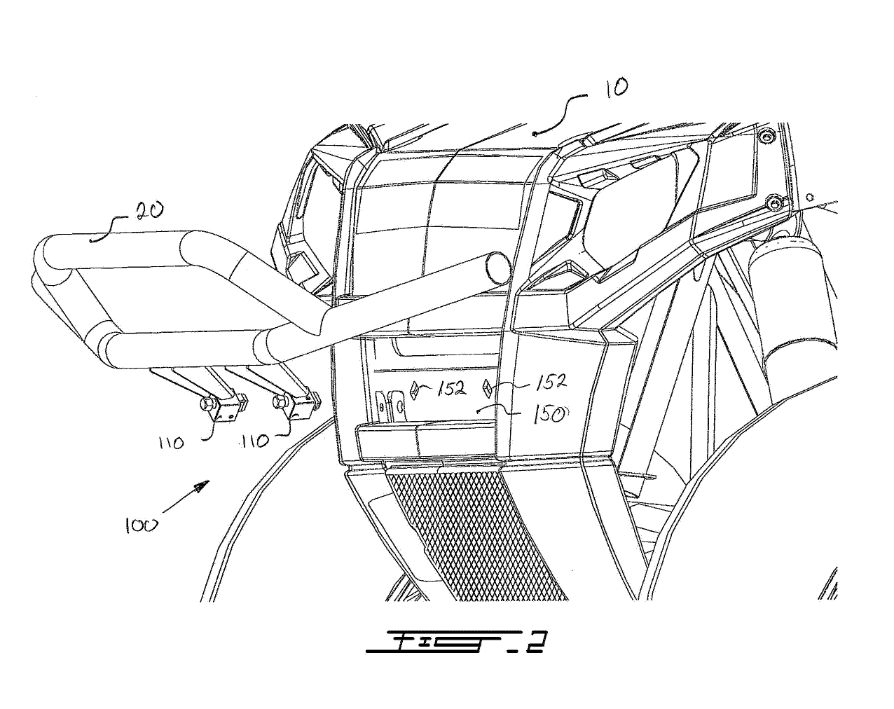

Referring now to FIG. 2, in the present embodiment, the attachment system 100 comprises two locking mechanism 110 and one receiving member 150 comprising two openings 152, one for each locking mechanism 110. Understandably, the attachment system 100 could comprise only one locking mechanism 110 or more than two locking mechanisms 110. Similarly, though the receiving member 150 is shown as comprising two openings 152, there could be two receiving members 150 each having one opening 152.

Hence, the attachment system 100 typically comprises at least one locking mechanism 110 and at least one receiving member 150 comprising at least one opening 152.

The locking mechanisms 110 are mounted to, or integral with, the bumper 20. In the present embodiment, the locking mechanisms 110 are integral with the bumper 20.

Similarly, the receiving member 150 is mounted to, or integral with, the vehicle 10. In that sense, the receiving member 150 could be secured to the vehicle where appropriate in order to allow the bumper 20 to be installed using the locking mechanisms 110. However, vehicles could also be pre-equipped with one or more receiving members 150 pre-assembled or integral with the frame of the vehicle such as to allow the bumper 20 to be installed using the locking mechanisms 110.

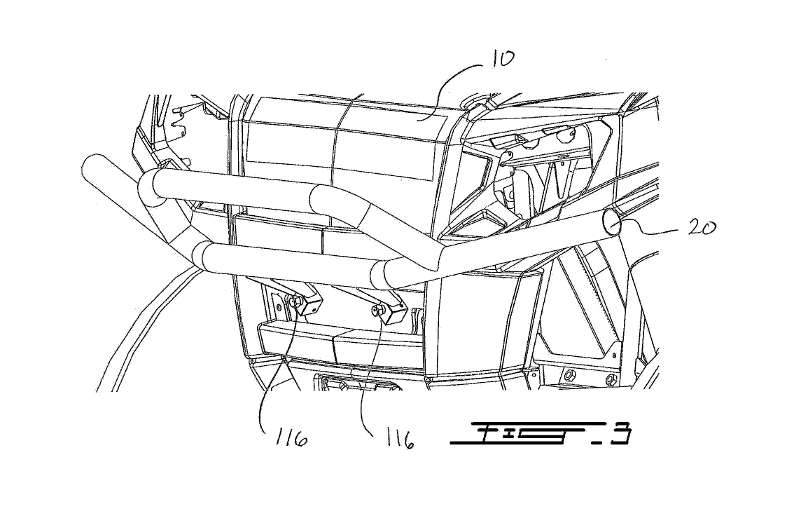

Referring now to FIGS. 3-4 and 5A to 5C, in the present embodiment, the receiving member 150 is a plate configured to be mounted to the vehicle 10 and which comprises the two openings 152.

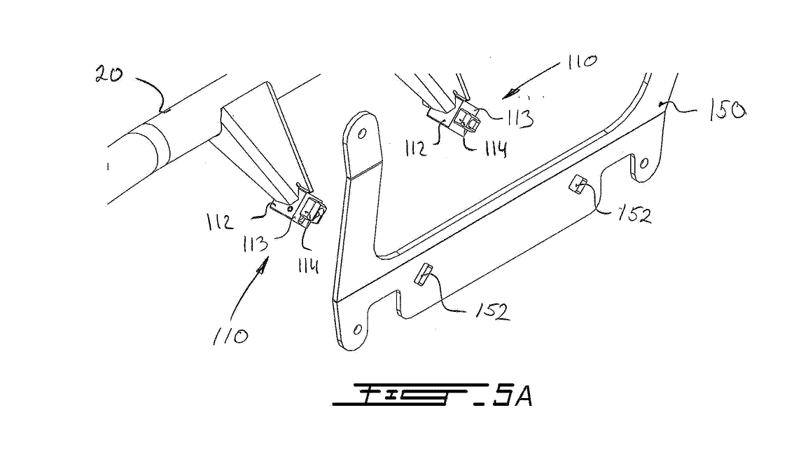

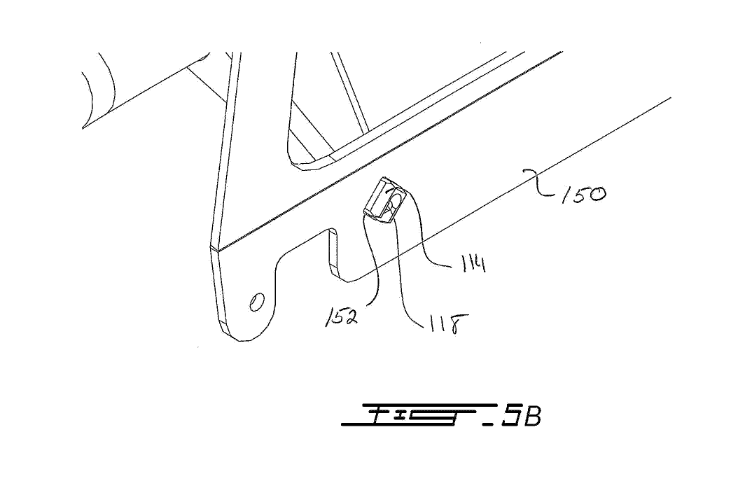

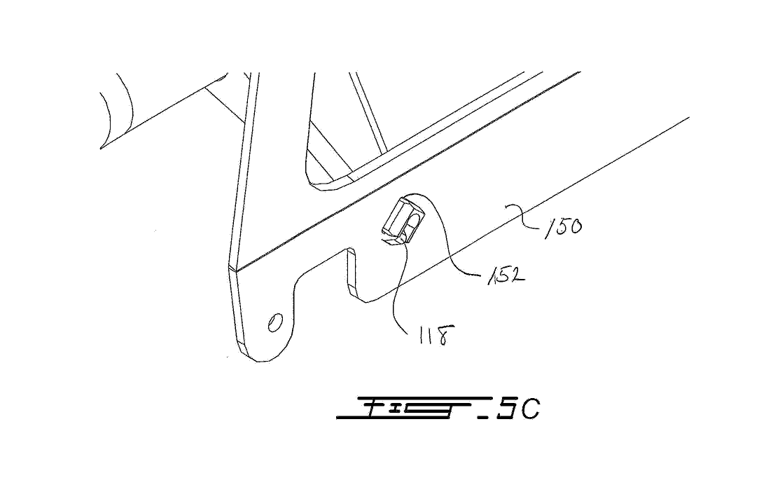

The locking mechanisms 110, which extend from the bumper 20, each comprises a housing 111 comprising a main portion 112 and a protruding plug portion 114 which defines a shoulder 113 with the main portion 112. As it will be best understood below, in the present embodiment, each locking mechanism 110 also comprises a threaded actuator 116 and a locking arm 118 displaceable, by the actuator 116, between an unlocked (or inoperative) position (see FIG. 5B) and a locked (or operative) position (see FIG. 5C).

Referring more particularly to FIGS. 5A to 5C, during installation, the plug portion 114 is inserted into the opening 152 until the shoulder 113 abuts on the receiving member 150. Then, the threaded actuator 116 (see FIG. 3) is actuated such as to displace the locking arm 118 from its unlocked position to its locked position in which the locking arm 118 engages the side 154 of the opening 152 (see FIG. 5C).

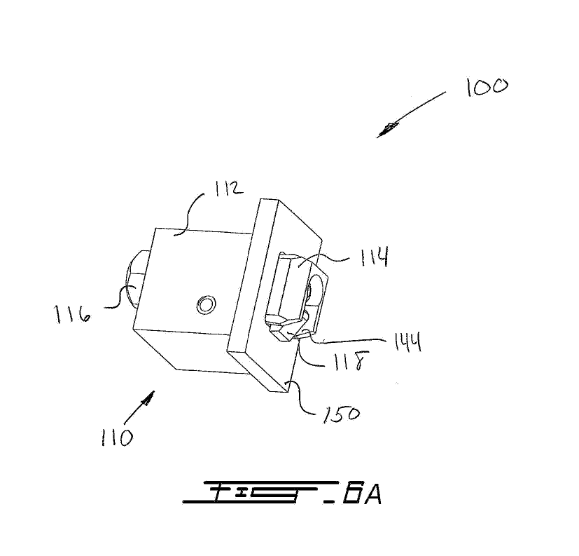

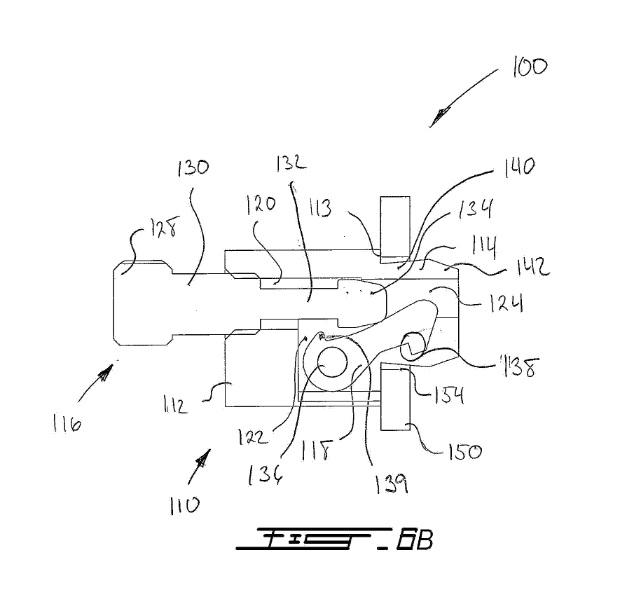

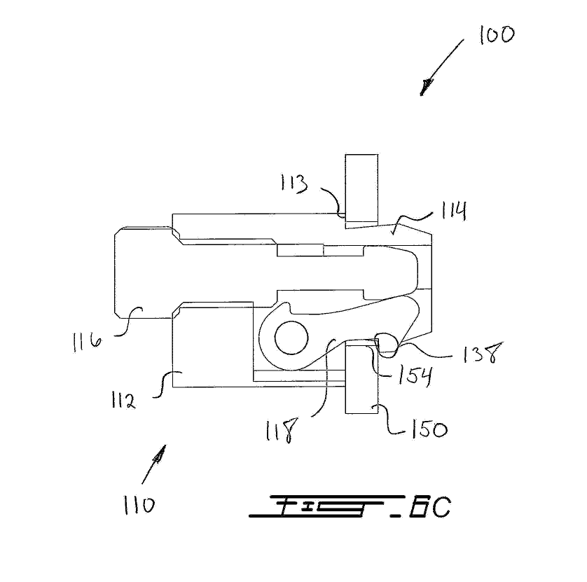

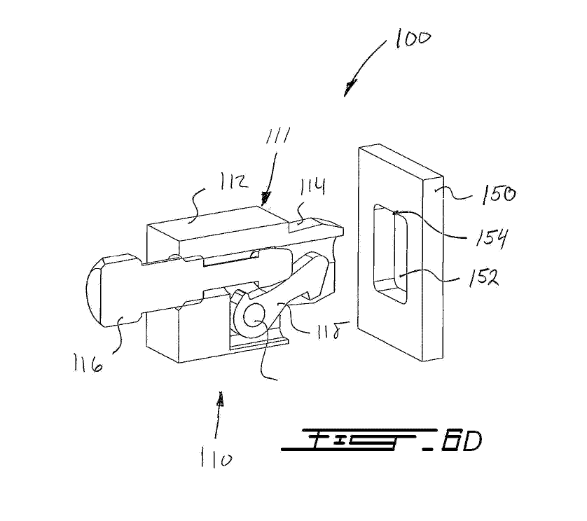

Referring now to FIGS. 6A to 6D, the first embodiment of the attachment system 100 will be described in more details.

As indicated above, the locking mechanism 110 of the attachment system 100 comprises a housing 111 comprising a main portion 112 and a plug portion 114 which defines a shoulder 113.

The main portion 112 generally comprises a threaded passage 120 which opens into an internal cavity 122. The internal cavity 122 further opens into a passage 124 in the plug portion 114.

The threaded passage 120 supports the threaded actuator 116. The threaded actuator 116 comprises a head 128, a threaded body 130, and a shank 132 terminated by a tapered actuating end 134.

The head 128 is typically engageable by a tool such as, but not limited to, a wrench, a socket, a screwdriver, an Allen key, pliers, etc. in order to allow the human operator to thread the actuator 116. In other embodiments, the head 128 could be made to be hand-actuated, allowing a human operator to thread the actuator 116 without any tool.

The actuating end 134 of the actuator 110 abuts on the locking arm 118 which is pivotally mounted in the internal cavity 122 at pivot 136. The locking arm 118 also extends in the passage 124 of the plug portion 114. The portion of the locking arm 118 which extends in the passage 124 is terminated by an engaging shoulder or hook 138 which is configured to engage the side 154 of the opening 152 of the receiving member 150 (see FIG. 6C).

In the present embodiment, the locking arm 118 also comprises a shoulder-shaped protrusion 139 configured to be engaged by the actuating end 134 when the actuator 116 is threaded in reverse. This protrusion 139 allows the actuator 116 to pivot the locking arm 118 from its locked position to its unlocked position.

The plug portion 114, which extends from the main portion 112, comprises a proximal portion 140 adjacent to the main portion 112, and a distal portion 142 extending from the proximal portion 140. As best shown in FIGS. 6B and 6C, the proximal portion 140 slightly flares while the distal portion 142 tapers. This configuration eases the insertion of the plug portion 114 into the opening 152.

The overall periphery of the plug portion 114 generally matches the shape of the opening 152 in order for the plug portion 114 to properly fit into the opening 152. In the present embodiment, the plug portion 114 is substantially rectangular.

Still, in the present embodiment, the plug portion 114 comprises a side opening 144 for allowing the engaging shoulder 138 of the locking arm 118 to engage the side 154 of the opening 152.

Referring more particularly to FIG. 6D, in the present embodiment, the receiving member 150 is a plate which can be mounted, or integral with, the vehicle 10. As already mentioned above, the receiving member 150 comprises at least one opening 152 which is shaped and sized for receiving the plug portion 114 of the locking mechanism 110.

During installation, the locking mechanism 110 is inserted into the opening 152 of the receiving member 150 such that the plug portion 114 extends into the opening 152 and such that the shoulder 113 abuts on the receiving member 150 (see FIG. 6B).

Then, the threaded actuator 116 is threaded, typically with a tool, such that the actuating end 134 displaces the locking arm 118 from its unlocked position (see FIG. 6B) to its locked position (see FIG. 6C).

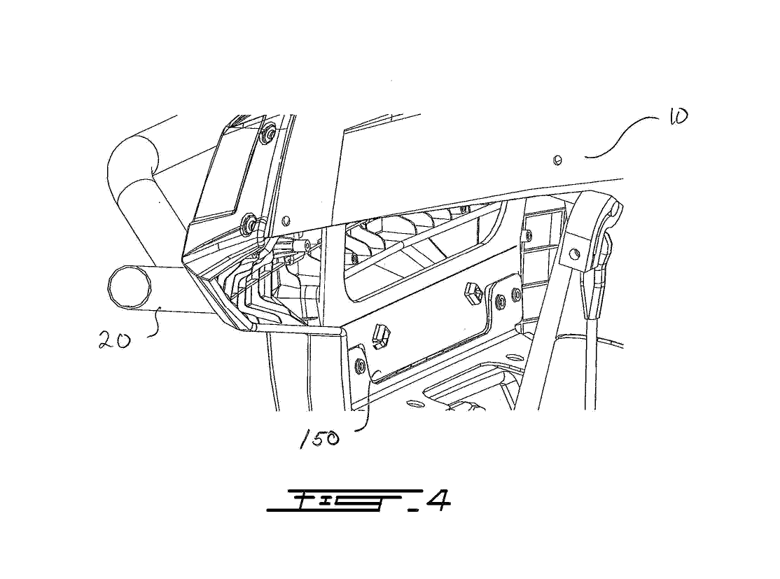

Once the locking arm 118 is in its locked position, the engaging shoulder 138 of the locking arm 118 engages the side 154 of the opening 152, thereby preventing the locking mechanism 110 from exiting the opening 152, and thereby securing the bumper 20 to the vehicle 10 (see FIGS. 3 and 4).

During removal, the threaded actuator 116 is threaded in reverse. As the actuator 116 is threaded in reverse, the actuating end 134 engages the protrusion 139 and forces the locking arm 118 to pivot back in its unlocked position. At this point, the locking mechanism 110 is free to exit the opening 152 of the receiving member 150.

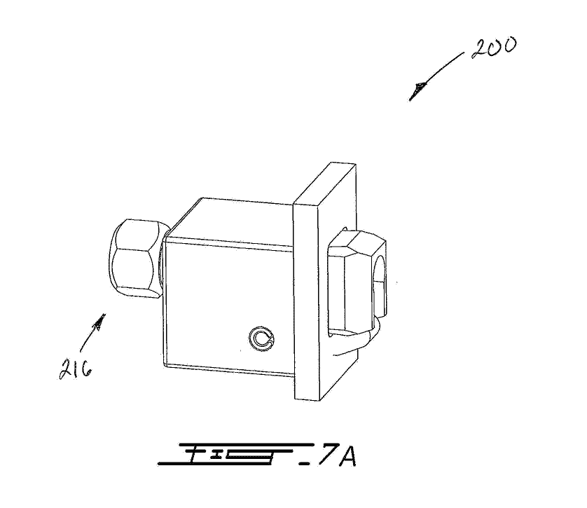

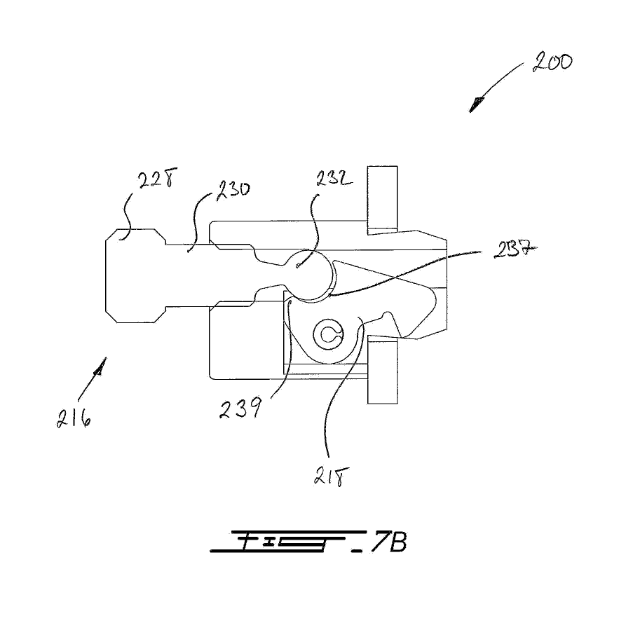

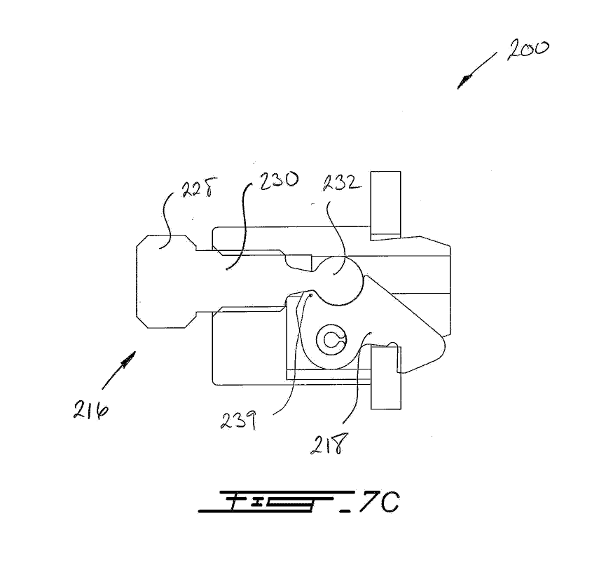

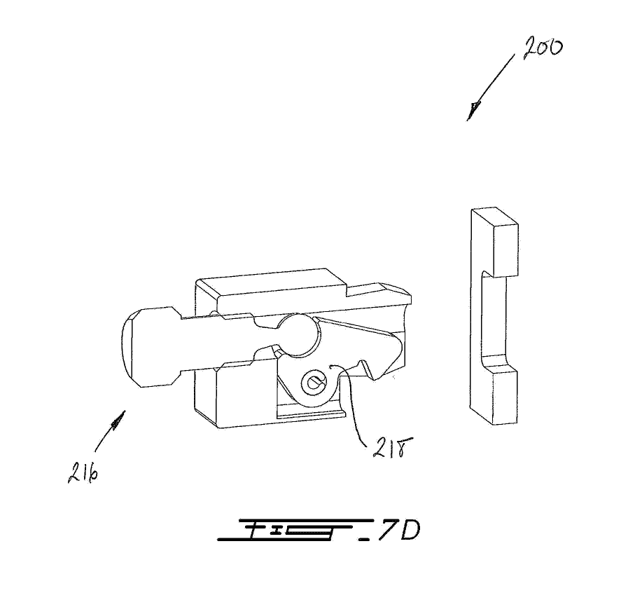

Referring now to FIGS. 7A to 7D, a second embodiment of an attachment system 200 in accordance with the principles of the present invention is shown.

The attachment system 200 is similar in configuration to the attachment system 100. The main differences are in the configuration of the threaded actuator 216, in the configuration of the locking arm 218, and in the engagement between the threaded actuator 216 and the locking arm 218.

In this embodiment, the threaded actuator 216 comprises a head 228, a threaded body 230, but is terminated by a generally spherical or cylindrical actuating end 232.

The locking arm 218 correspondingly comprises a generally semi-spherical or semi-cylindrical recess 237 configured to receive the spherical or cylindrical actuating end 232 and having a protrusion 239 configured to be engaged by the actuating end 232 when the actuator 216 is threaded in reverse.

Hence, when the threaded actuator 216 is threaded, the actuating end 232 will engage the recess 237 and cause the displacement of the locking arm 218 from its unlocked position (see FIG. 7B) to its locked position (see FIG. 7C). When the threaded actuator 216 is threaded in reverse, the actuating end 232 engages the protrusion 239 and forces the locking arm 218 to pivot back in its unlocked position.

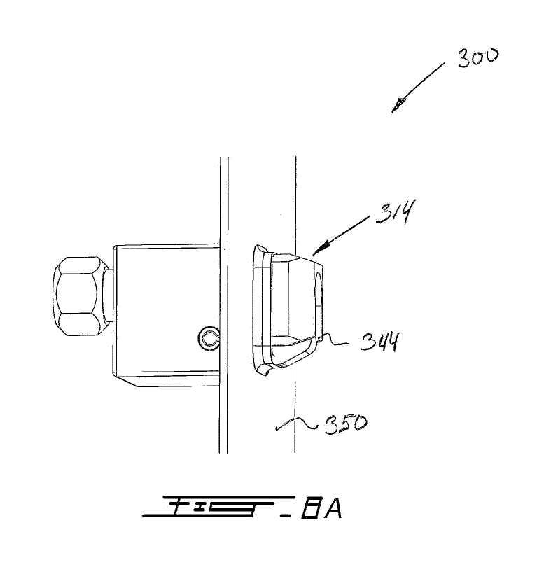

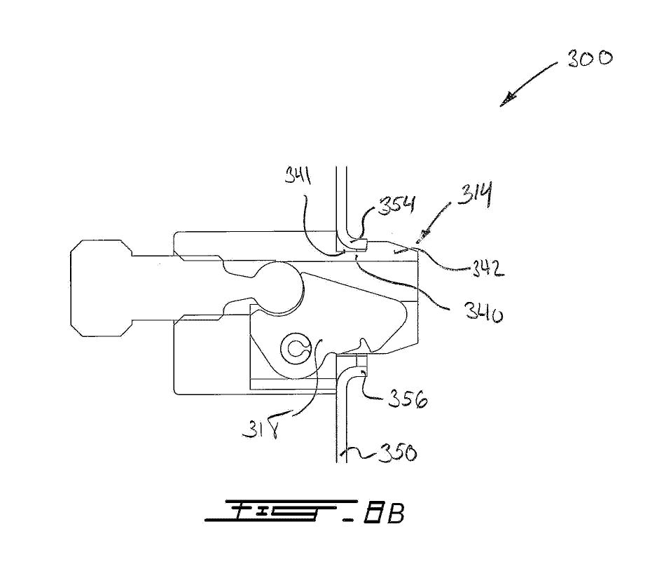

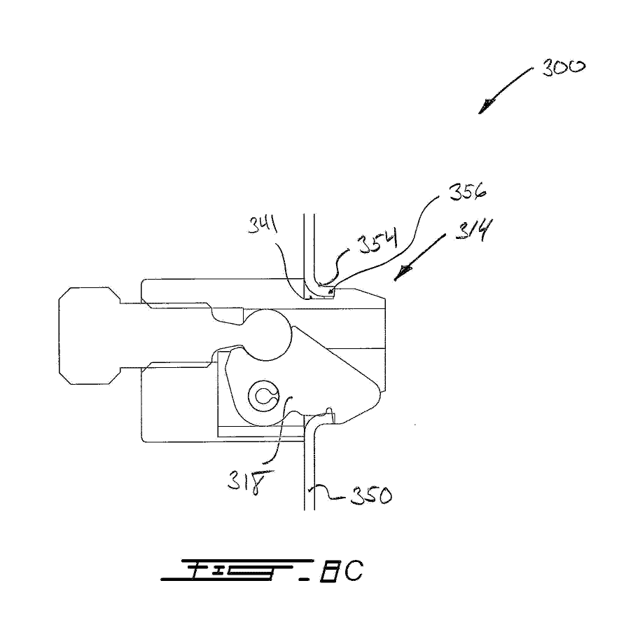

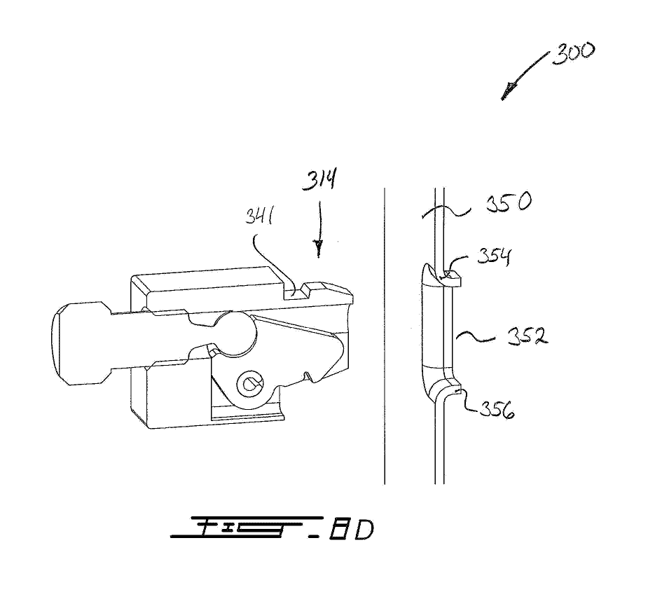

Referring now to FIGS. 8A to 8D, a third embodiment of an attachment system 300 in accordance with the principles of the present invention is shown.

The attachment system 300 is similar in configuration to the attachment system 200. The main differences are in the configuration of the plug portion 314, in the configuration of the receiving member 350, and in the engagement between the plug portion 314 and the receiving member 350.

In the third embodiment, the plug portion 314 still comprises a proximal portion 340 and a distal portion 342. However, the proximal portion 340, instead of being flared, is generally straight but comprises a groove 341. The groove 341 is located opposite the opening 344 (see FIG. 8A), and is configured to engage the side 354 of the opening 352 of the receiving member 350 as best shown in FIGS. 8B and 8C.

Hence, when the locking arm 318 is in its locked position as in FIG. 8C, both the locking arm 318 and the groove 341 of the plug portion 314 engage the sides 354 of the opening 352. Furthermore, as the locking arm 318 engages the side 354 of the opening 352, the locking arm 318 causes the plug portion 314, and thus the groove 341, to move in the opposite direction, thereby further securing the locking mechanism 310 to the receiving member 350.

Also, in this third embodiment, the opening 352 further comprises an inner (i.e. facing the vehicle 10) peripheral rib or flange 356 which is engaged by the groove 341 and by the locking arm 318 (see FIG. 8C). The peripheral rib 356 generally reinforces the periphery of the opening 352.

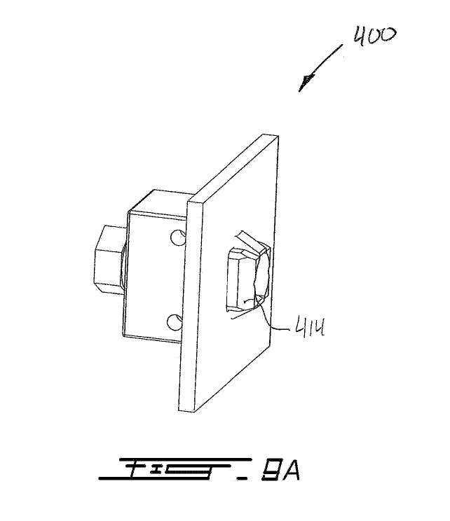

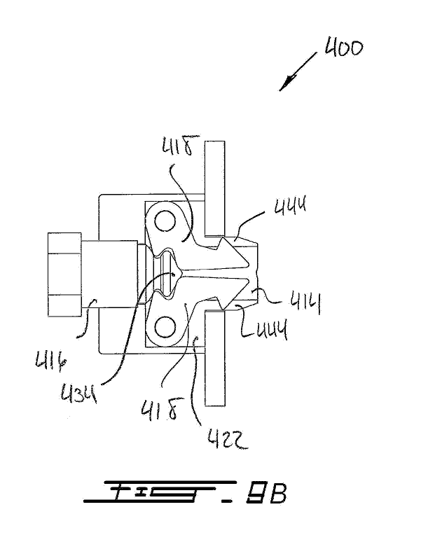

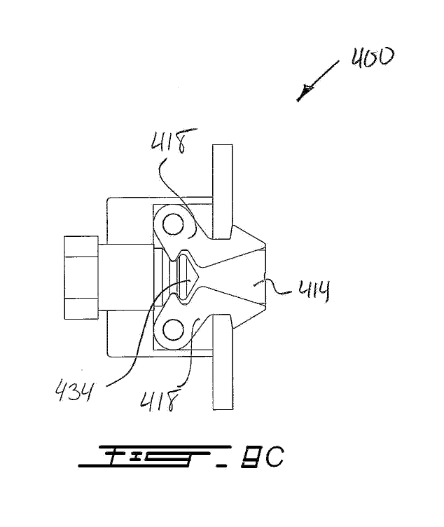

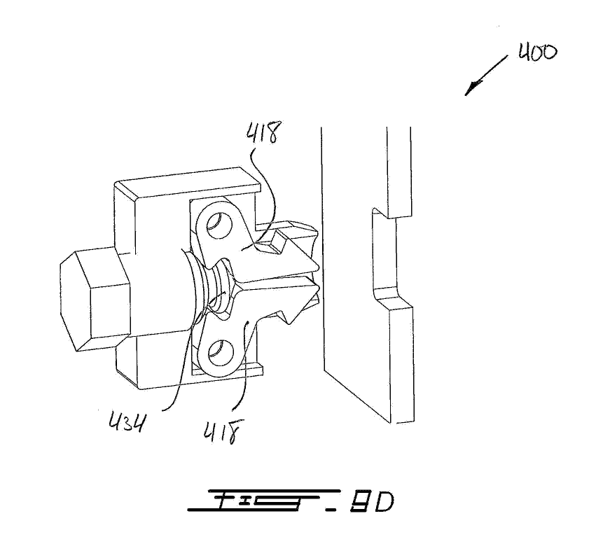

Referring now to FIGS. 9A to 9D, a fourth embodiment of an attachment system 400 in accordance with the principles of the present invention is shown.

The attachment system 400 generally works on the same principles as the attachment system 100 but comprises two locking arms 418 engaged by a single threaded actuator 416.

To accommodate two locking arms 418, the inner cavity 422 is made larger and the plug portion 414 comprises two opposite side openings 444.

In addition, as best shown in FIGS. 9B and 9C, the configurations of the actuating end 434 and of the locking arms 418 differ from the configurations of the actuating end 134 and of the locking arm 118. Still, the locking arms 418 are configured to pivot as the threaded actuator 416 pushes (or pulls) on them as illustrated in FIGS. 9B and 9C.

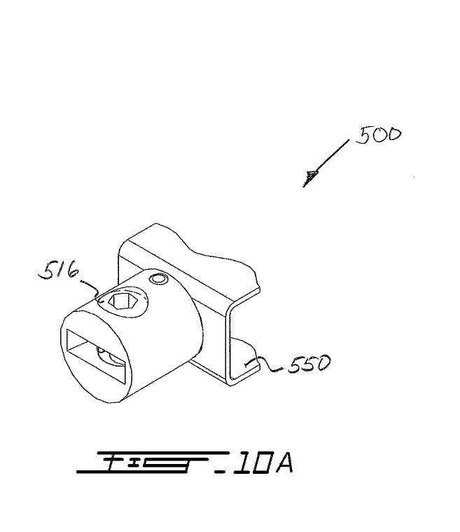

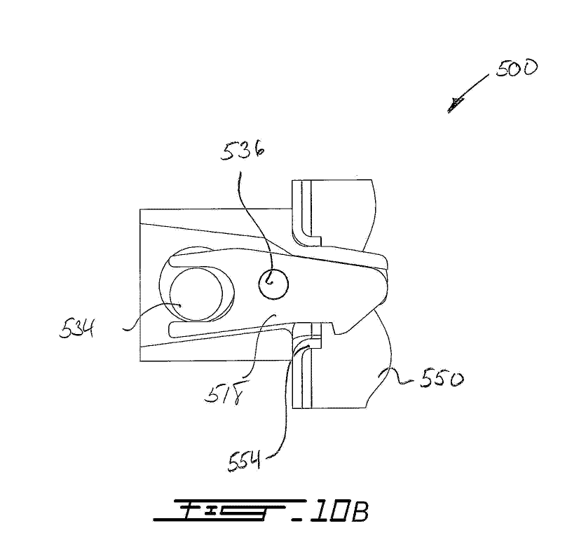

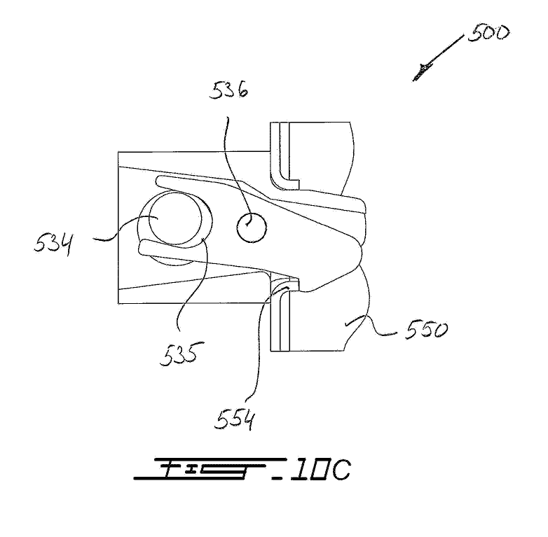

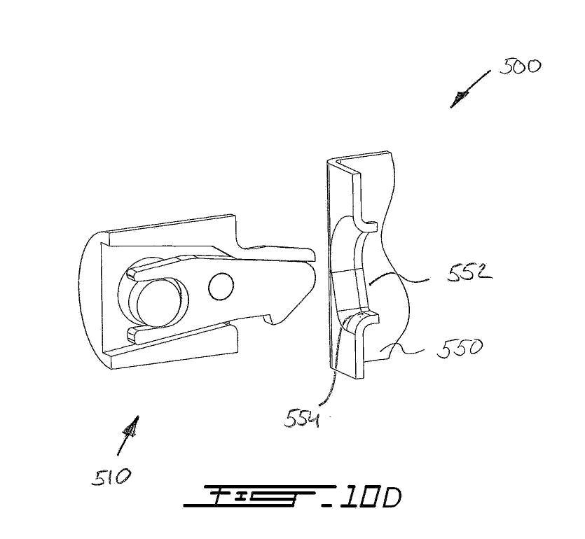

Referring now to FIGS. 10A to 10D, a fifth embodiment of an attachment system 500 in accordance with the principles of the present invention is shown.

Attachment system 500 still comprise a locking mechanism 510 and a receiving member 550 but the engagement between the actuator 516 and the locking arm 518 differs from the previous four embodiments.

Indeed, in the attachment system 500, the actuator 516 is terminated by an eccentric cylindrical engaging end 534 which is received into a generally U-shaped recess 535 formed in the locking arm 518.

Hence, as best shown in FIGS. 10B and 10C, when the actuator 516 is rotated, the eccentric movement of the engaging end 534 forces the locking arm 518 to pivot about pivot 536, and thus forces the locking arm 534 from its unlocking position (see FIG. 10B) to its locked position (see FIG. 10C) where the locking arm 518 engages the side 554 of the opening 552 in the receiving member 550.

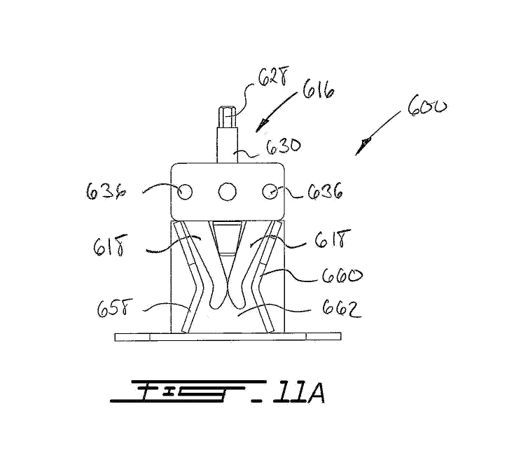

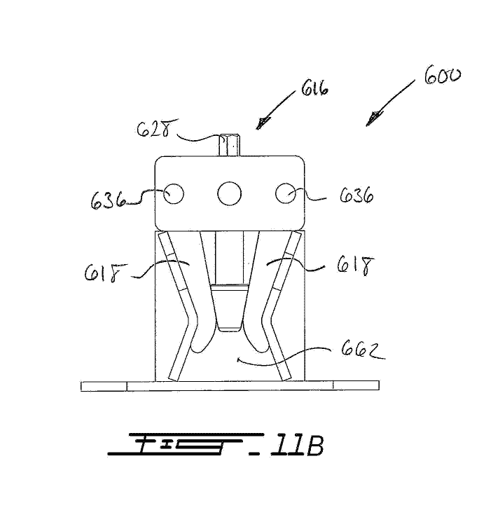

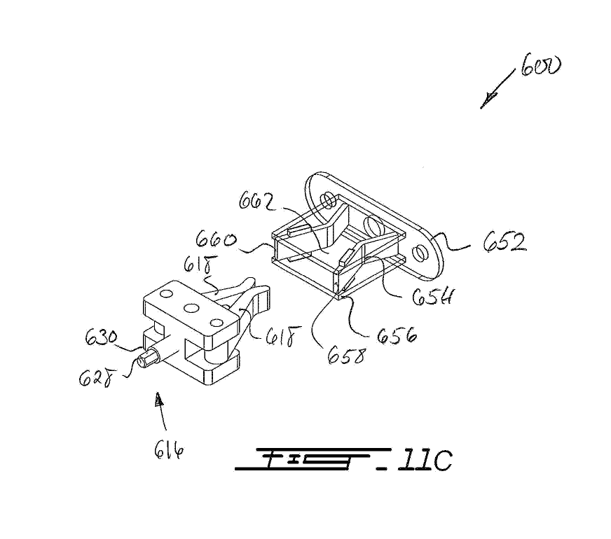

Referring now to FIGS. 11A to 11C, a sixth embodiment of an attachment system 600 in accordance with the principles of the present invention is shown.

The attachment system 600 comprises a locking mechanism 610 and a receiving member 650.

In this sixth embodiment, the receiving member 650 is more complex than the receiving members 150-550 described above. The receiving member 650 generally comprises a back plate 652 configured to be secured to the vehicle 10, a pair of spaced apart walls 654 and 656, and a pair of angular walls 658 and 660. The walls 654, 656 and 658, 660 define an inner space 662 configured to receive the locking arms 618 of the locking mechanism 610.

The locking mechanism 610 generally comprises a housing 612 which pivotally supports the two locking arms 618 via pivots 636.

The main body 612 also comprises a threaded passage (not shown) which supports a threaded actuator 616.

The threaded actuator 616 comprises a head 628 generally configured to be engaged by a tool, a threaded body 630, and an actuating end 634 configured to engage the locking arms 618.

During installation, the locking arms 618, in their unlocked position, are inserted into the space 662 as best shown in FIG. 11A. Then, the actuator 616 is threaded and displaces the locking arms 618 from their unlocked position (see FIG. 11A) to their locked position (see FIG. 11B) in which they respectively engage the angular walls 658 and 660 as best shown in FIG. 11B.

To remove the locking mechanism 610, the actuator 616 is threaded in reverse, the locking arms 618 are free to pivot back in their unlocked position, and the locking mechanism 610 is free to exit the receiving member 650.

Understandably, even though several embodiments of attachment systems have bee disclosed, other embodiments are possible. For instance, other embodiments could include combinations of the embodiments described above.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A locking mechanism for use with a receiving member comprising an opening, the locking mechanism comprising:
a) a housing;
b) at least one locking arm pivotally mounted to the housing, the at least one locking arm being displaceable between an inoperative position and an operative position;
c) an actuator pivotally mounted to the housing, the actuator comprising a first extremity and a second extremity, the second extremity being configured to engage the at least one locking arm, the actuator being configured to cause the displacement of the at least one locking arm between the inoperative position and the operative position.

2) A locking mechanism as claimed in claim 1, wherein the housing comprises a main portion and a plug portion extending from the main portion, the plug portion defining a shoulder with the main portion, the plug portion comprising a free extremity.

3) A locking mechanism as claimed in claim 2, wherein the plug portion has a cross- section substantially complementary to a shape of the opening.

4) A locking mechanism as claimed in claim 2, wherein the free extremity of the plug portion is tapered.

5) A locking mechanism as claimed in claim 2, wherein the plug portion comprises at least one side opening through which a portion of the at least one locking arm can extend.

6) A locking mechanism as claimed in claim 5, wherein the plug portion comprises a groove opposite the at least one side opening, the groove being located near the shoulder.

7) A locking mechanism as claimed in claim 1, wherein the at least one locking arm comprises an engaging portion configured to engage a side of the opening when in the operative position.

8) A locking mechanism as claimed in claim 7, wherein the engaging portion is substantially hook-shaped.

9) A locking mechanism as claimed in claim 7, wherein the engaging portion is located at an extremity of the at least one locking arm.

10) A locking mechanism as claimed in claim 1, wherein the first extremity of the actuator is configured to be engaged by a tool.

11) A locking mechanism as claimed in claim 1, wherein the second extremity of the actuator is tapered.

12) A locking mechanism as claimed in claim 1, wherein the actuator is threaded.

13) An accessory comprising at least one locking mechanism as claimed in claim 1.

14) An accessory as claimed in claim 13, wherein the at least one locking mechanism is mounted thereto.

15) An accessory as claimed in claim 13, wherein the at least one locking mechanism is integral therewith.

16) An accessory as claimed in claim 13, wherein the accessory is a bumper.

17) An attachment system for mounting an accessory to a vehicle, the attachment system comprising:
a) at least one locking mechanism comprising:
i) a housing;
ii) at least one locking arm pivotally mounted to the housing, the at least one locking arm being displaceable between an inoperative position and an operative position;
iii) an actuator pivotally mounted to the housing, the actuator comprising a first extremity and a second extremity, the second extremity being configured to engage the at least one locking arm, the actuator being configured to cause the displacement of the at least one locking arm between the inoperative position and the operative position;
b) at least one receiving member comprising:
i) at least one opening;
wherein the at least one locking mechanism is configured to be at least partially received into the at least one opening such that the at least one locking arm can engage a side of the at least one opening when in the operative position.

18) An attachment system as claimed in claim 17, wherein the housing comprises a main portion and a plug portion extending from the main portion, the plug portion defining a shoulder with the main portion, the plug portion being configured to be received into the at least one opening, the plug portion comprising a free extremity.

19) An attachment system as claimed in claim 18, wherein the plug portion has a cross-section substantially complementary to a shape of the at least one opening.

20) An attachment system as claimed in claim 18, wherein the free extremity of the plug portion is tapered.

21) An attachment system as claimed in claim 18, wherein the plug portion comprises at least one side opening through which a portion of the at least one locking arm can extend.

22) An attachment system as claimed in claim 21, wherein the plug portion comprises a groove opposite the at least one side opening, the groove being located near the shoulder.

23) An attachment system as claimed in claim 17, wherein the at least one locking arm comprises an engaging portion configured to engage the side of the at least one opening when in the operative position.

24) An attachment system as claimed in claim 23, wherein the engaging portion is substantially hook-shaped.

25) An attachment system as claimed in claim 23, wherein the engaging portion is located at an extremity of the at least one locking arm.

26) An attachment system as claimed in claim 17, wherein the first extremity of the actuator is configured to be engaged by a tool.

27) An attachment system as claimed in claim 17, wherein the second extremity of the actuator is tapered.

28) An attachment system as claimed in claim 17, wherein the actuator is threaded.

29) An attachment system as claimed in claim 17, wherein the at least one locking mechanism is mounted to the accessory.

30) An attachment system as claimed in claim 17, wherein the at least one locking mechanism is integral with the accessory.

31) An attachment system as claimed in claim 17, wherein the at least one receiving member is mounted to the vehicle.

32) An attachment system as claimed in claim 17, wherein the at least one receiving member is integral with the vehicle.

33) A method to install an accessory on a vehicle using an attachment system as claimed in claim 17, the accessory comprising the at least one locking mechanism, the vehicle comprising the at least one receiving member comprising the at least one opening, the method comprising:
a) partially inserting the at least one locking mechanism in the at least one opening;
b) rotating the actuator to pivot the at least one locking arm from the inoperative position to the operative position such that the at least one locking arm engages the side of the at least one opening;
whereby the at least one locking arm engages the side of the at least one opening when in the operative position.
